(19) United States
(12) Patent Application Publication
(10) Pub. No.: US 2013/0319464 A1
(43) Pub. Date: Dec. 5, 2013

(54) Heat Exchanger Pipework Cleaning Apparatus and Method

(71) Applicant: Peter Derek Barrett, Burwash (GB)

(72) Inventor: Peter Derek Barrett, Burwash (GB)

(21) Appl. No.: 13/485,992

(22) Filed: Jun. 1, 2012

(51) Int. Cl. F28G 9/00; B08B 9/032; B01D 35/02; C02F 1/00

(52) U.S. Cl. 134/10; 165/95; 210/167.01

(57) ABSTRACT

A closed-loop heat exchanger pipework cleaning apparatus includes a water conditioning apparatus and a pipework conditioning apparatus. The water conditioning apparatus is adapted to receive water and to remove particulate contaminants from the water and to kill microorganisms in the water, to produce conditioned water, and to deliver the conditioned water into a closed-loop pipework system of a heat exchanger until the closed-loop pipework system is substantially full of water. The pipework conditioning apparatus is adapted to receive a proportion of the water circulating through the closed-loop pipework system and to remove further particulate contaminants from the water to produce cleaned water, and to return the cleaned water into the closed-loop pipework system.

### BACKGROUND

1. Field

The present application relates to heat exchanger pipework cleaning apparatus, and to a heat exchanger incorporating the cleaning apparatus. The present application also relates to a method of cleaning a heat exchanger that includes a closed-loop pipework system.

2. Related Art

Water-filled heating and cooling pipework systems, such as air-conditioning systems, need to be cleaned prior to the system being commissioned, as set out in the Building Services Research and Information Association (BSRIA) Guide BG29/2011 “Pre-Commission Cleaning of Pipework Systems”. These pipework systems may also be required to be cleaned periodically during their operating lifetime. In both instances this is currently achieved by flushing large volumes (often millions of liters) of fresh water though the pipework system, creating large volumes of effluent which is disposed of to drain. The process of flushing fresh water through a newly constructed pipework system creates large amounts of corrosion within the pipework system and leads to corrosion debris, which must be removed using chemical cleaning agents. The existing process therefore also creates a large quantity of chemical effluent.

### SUMMARY

In accordance with a first aspect of the present application, a closed-loop heat exchanger pipework cleaning apparatus includes a pipework conditioning apparatus adapted to receive a proportion of the water circulating through a closed-loop pipework system of a heat exchanger and to remove particulate contaminants from the received water to produce cleaned water, and to return the cleaned water into the closed-loop pipework system. The pipework conditioning apparatus may therefore be used to condition the pipework system by removing contaminants such as corrosion debris, debris which has entered the pipework during installation of the pipework and biological material which is present within the pipework. The heat exchanger pipework cleaning apparatus may therefore be operated to clean a closed-loop pipework system of a heat exchanger without flushing large volumes of water through the pipework system and without generating large volumes of effluent which must be disposed of. By retaining the water within the pipework system greater control of the chemistry within the pipework system may be achieved. The heat exchanger pipework cleaning apparatus may reduce fresh water usage and chemical effluent creation by a factor of up to 1000 as compared to the prior art.

Preferably, the pipework cleaning apparatus further includes a water conditioning apparatus which is adapted to receive water and to remove further particulate contaminants from the water and to kill microorganisms in the water, to produce conditioned water, and to deliver the conditioned water into a closed-loop pipework system of the heat exchanger until the closed-loop pipework system is substantially full of water. The water conditioning apparatus is therefore able to deliver conditioned water into a closed-loop pipework system of a heat exchanger, which may preventingress of physical and microbiological contaminants into the pipework system.

A heat exchanger is used herein to mean both heating and cooling systems. Closed-loop is used herein to mean a pipework system which is closed during normal operation. It will be appreciated that the pipework system must be able to be selectively opened to deliver conditioned water into it and to allow the pipework conditioning apparatus to receive water from it. Particulate is used herein to mean any sized contaminant which is small enough to be carried in and by the water.

Preferably, the pipework conditioning apparatus includes:

a first water inlet adapted to divert said proportion of the water into the pipework conditioning apparatus from the closed-loop pipework system;

first filtration apparatus adapted to remove said particulate contaminants from the water diverted from the closed-loop pipework system to produce the cleaned water; and

a first water outlet adapted to deliver the cleaned water into the closed-loop pipework system.

Preferably, the water conditioning apparatus includes:

a second water inlet adapted to receive the water;

second filtration apparatus adapted to remove said particulate contaminants from the water;

disinfection apparatus adapted to kill said microorganisms in the water; and

a second water outlet adapted to deliver the conditioned water into the closed-loop pipework system.

The second filtration apparatus may allow particulate contaminants above a predetermined size to be removed from water received through the second water inlet. The disinfection apparatus may allow at least a percentage of microorganisms present in the water to be killed. The water may be raw water, being untreated water, for example rain water or river water, or the water may be from a mains water supply.

In an embodiment, the closed-loop pipework system has a volumetric capacity and the first water inlet includes a valve arrangement adapted to divert a volume of the water circulating through the closed-loop pipework system substantially equivalent to said volumetric capacity into the pipework conditioning apparatus in a period of substantially one hour. Rapid conditioning of the pipework system may therefore be achieved.

The pipework conditioning apparatus may further include a de-aerator. Removing air from the water circulating through the pipework system may reduce the growth of microorganisms in the water and may reduce the introduction of particulate contaminants and biological material into the water due to impact of air bubbles with internal surfaces of the pipework system.

Preferably, the water conditioning apparatus further includes a biological filtration apparatus adapted to receive the conditioned water from the disinfection apparatus and to remove biological material from the conditioned water. In an embodiment, the biological filtration apparatus includes a microbiological filter and a microbiological membrane barrier arranged in series. Microorganisms which have been killed by the disinfection apparatus and biological material present within the water received from the second water inlet may therefore be removed from the water before it is delivered into the pipework system.

Preferably, at least one of the water conditioning apparatus and the pipework conditioning apparatus further includes a conditioning chemical delivery apparatus adapted to deliver a dose of at least one of an anti-corrosion chemical composition, a water conditioning chemical composition and an anti-microbial chemical composition into the conditioned water or the cleaned water respectively prior to the said water being delivered into the closed-loop pipework system. The presence of an anti-corrosion chemical composition in the water may reduce the amount of corrosion which occurs on the internal surfaces of the pipework system, thus reducing the amount of corrosion debris which may build up in the water circulating through the pipework system, both during filling of the pipework system with the water and during operation of the heat exchanger. The presence of an anti-corrosion chemical composition in the conditioned water may also reduce the amount of corrosion produced as compared to the prior art in which fresh water is used. The presence of a water conditioning chemical composition in the water may inhibit the formation of scale on the internal surfaces of the pipework system, thus reducing the amount of scale debris which may build up in the water circulating through the pipework system. The presence of an anti-microbial chemical composition in the water may inhibit the growth of biological material within the pipework system, thus reducing the amount of biological material which may be introduced into the pipework system and which may build up in the water circulating through the pipework system. The amount of anti-microbial chemical composition required to inhibit growth of biological material may be reduced as a result of the water conditioning apparatus having killed microorganisms in the water.

In an embodiment, at least one of the water conditioning apparatus and the pipework conditioning apparatus further includes a microorganism sampling apparatus arranged to receive a sample of the water and to test the water for microbiological levels. The microorganism sampling apparatus preferably includes an adenosine triphosphate testing apparatus. Adenosine triphosphate (ATP) is a molecule which is found in and around living cells and testing for adenosine triphosphate is a well known method of measuring the levels of actively growing microorganisms. The levels of microbiological activity within the water in the heat exchanger pipework cleaning apparatus may therefore be rapidly measured. The amount of anti-microbial chemical composition required to be dosed into the water may therefore be determined.

In an embodiment, the heat exchanger further includes a secondary pipework system, and the heat exchanger pipework cleaning apparatus further includes back-flushing apparatus that includes:

a third filtration apparatus adapted to receive water from the secondary pipework system and to remove further particulate contaminants to produce further cleaned water; and

a third water output adapted to return the further cleaned water into the closed-loop pipework system.

The heat exchanger pipework cleaning apparatus may be used to separately clean secondary pipework systems which are isolated from the closed-loop pipework system during cleaning of the closed-loop pipework system.

In an embodiment, the back-flushing apparatus further includes a water tank, provided between the secondary pipework system and the third filtration apparatus and adapted to receive the water from the secondary pipework system, the third filtration apparatus being arranged to receive the water from the water tank. Water may therefore be flushed through the secondary pipework system into the tank at a higher rate than the flow capacity of the third filtration apparatus or a time when it is not possible to return cleaned water into the closed-loop pipework system, with the flushed water then being passed through the third filtration apparatus at a lower rate or at a later time.

The heat exchanger may include an air-conditioning system.

In accordance with a second aspect of the present application, a heat exchanger including:

a closed-loop pipework system; and

a closed-loop heat exchanger pipework cleaning apparatus that includes a pipework conditioning apparatus adapted to receive a proportion of the water circulating through the closed-loop pipework system and to remove further particulate contaminants from the received water to produce cleaned water, and to return the cleaned water into the closed-loop pipework system.

The pipework conditioning apparatus is able to remove particulate contaminants from the water circulating through the pipework system and return the cleaned water into the pipework system. The pipework conditioning apparatus may therefore be used to condition the pipework system by removing contaminants such as corrosion debris, debris which has entered the pipework during installation of the pipework and biological material which is present within the pipework. The closed-loop pipework system of the heat exchanger may therefore be cleaned without the need to flush large volumes of water through the pipework system and without generating large volumes of effluent which must be disposed of.

Preferably, the heat exchanger of the second aspect, further includes a water conditioning apparatus adapted to receive water and to remove particulate contaminants from the water and to kill microorganisms in the water, to produce conditioned water, and to deliver the conditioned water into a closed-loop pipework system of the heat exchanger until the closed-loop pipework system is substantially full of water. The closed-loop pipework system heat exchanger may therefore be filled with conditioned water, which may preventingress of physical and microbiological contaminants into the pipework system.

Preferably, the pipework conditioning apparatus includes:

a first water inlet adapted to divert said proportion of the water into the pipework conditioning apparatus from the closed-loop pipework system;

a first filtration apparatus adapted to remove said further particulate contaminants from the water diverted from the closed-loop pipework system to produce the cleaned water; and

a first water outlet adapted to deliver the cleaned water into the closed-loop pipework system.

Preferably, the water conditioning apparatus includes:

a second water inlet adapted to receive the water;

a second filtration apparatus adapted to remove said particulate contaminants from the water;

a disinfection apparatus adapted to kill said microorganisms in the water; and

a second water outlet adapted to deliver the conditioned water into the closed-loop pipework system.

The second filtration apparatus may allow particulate contaminants above a predetermined size to be removed from water received through the second water inlet. The disinfection apparatus may allow at least a percentage of microorganisms present in the water to be killed. The water may be raw water, being untreated water, for example rain water or river water, or the water may be from a mains water supply.

In an embodiment, the closed-loop pipework system has a volumetric capacity and the first water inlet includes a valve arrangement adapted to divert a volume of the water circulating through the closed-loop pipework system substantially equivalent to said volumetric capacity into the pipework conditioning apparatus in a period of substantially one hour. Rapid conditioning of the pipework system may therefore be achieved.

The pipework conditioning apparatus may further include a de-aerator. Removing air from the water circulating through the pipework system may reduce the growth of microorganisms in the water and may reduce the introduction of particulate contaminants and biological material into the water due to impact of air bubbles with internal surfaces of the pipework system.

Preferably, the water conditioning apparatus further includes a biological filtration apparatus adapted to receive the conditioned water from the disinfection apparatus and to remove biological material from the conditioned water. In an embodiment, the biological filtration apparatus includes a microbiological filter and a microbiological membrane barrier arranged in series. Microorganisms which have been killed by the disinfection apparatus and biological material present within the water received from the second water inlet may therefore be removed from the water before it is delivered into the pipework system.

Preferably, at least one of the water conditioning apparatus and the pipework conditioning apparatus further includes a conditioning chemical delivery apparatus adapted to deliver a dose of at least one of an anti-corrosion chemical composition, a water conditioning chemical composition and an anti-microbial chemical composition into the conditioned water or the cleaned water respectively prior to the said water being delivered into the closed-loop pipework system. The presence of an anti-corrosion chemical composition in the water may reduce the amount of corrosion which occurs on the internal surfaces of the pipework system, thus reducing the amount of corrosion debris which may build up in the water circulating through the pipework system, both during filling of the pipework system with the water and during operation of the heat exchanger. The presence of an anti-corrosion chemical composition in the conditioned water may also reduce the amount of corrosion produced as compared to the prior art in which fresh water is used. The presence of a water conditioning chemical composition in the water may inhibit the formation of scale on the internal surfaces of the pipework system, thus reducing the amount of scale debris which may build up in the water circulating through the pipework system. The presence of an anti-microbial chemical composition in the water may inhibit the growth of biological material within the pipework system, thus reducing the amount of biological material which may be introduced into the pipework system and which may build up in the water circulating through the pipework system. The amount of anti-microbial chemical composition required to inhibit growth of biological material may be reduced as a result of the water conditioning apparatus having killed microorganisms in the water.

In an embodiment, at least one of the water conditioning apparatus and the pipework conditioning apparatus further includes a microorganism sampling apparatus arranged to receive a sample of the water and to test the water for microbiological levels. The microorganism sampling apparatus preferably includes an adenosine triphosphate testing apparatus. Adenosine triphosphate (ATP) is a molecule which is found in and around living cells and testing for adenosine triphosphate is a well known method of measuring the levels of actively growing microorganisms. The levels of microbiological activity within the water in the heat exchanger pipework cleaning apparatus may therefore be rapidly measured. The amount of anti-microbial chemical composition required to be dosed into the water may therefore be determined.

In an embodiment, the heat exchanger further includes a secondary pipework system, and the heat exchanger pipework cleaning apparatus further includes a back-flushing apparatus that includes:

a third water inlet adapted to divert water from the closed-loop pipework system into the secondary pipework system;

a third filtration apparatus adapted to receive water from the secondary pipework system and to remove further particulate contaminants to produce further cleaned water; and

a third water output adapted to return the cleaned water into the closed-loop pipework system.

A secondary pipework system which is isolated from the closed-loop pipework system during cleaning of the closed-loop pipework system can therefore be cleaned separately.

The third water inlet may include a by-pass valve provided between the closed-loop pipework system and the secondary pipework system.

The back-flushing apparatus may further include a water tank, provided between the secondary pipework system and the third filtration apparatus and adapted to receive the water from the secondary pipework system, the third filtration apparatus being arranged to receive the water from the water tank. Water may therefore be flushed through the secondary pipework system into the tank at a higher rate than the flow capacity of the third filtration apparatus or a time when it is not possible to return cleaned water into the closed-loop pipework system, with the flushed water then being passed through the third filtration apparatus at a lower rate or at a later time.

The heat exchanger may include an air-conditioning system.

In accordance with a third aspect of the present application, a method of cleaning a closed-loop heat exchanger pipework system, includes:

receiving water;

delivering the water into a closed-loop pipework system of a heat exchanger until the closed-loop pipework system is substantially full of water;

causing the water to circulate through the closed-loop pipework system;

diverting a proportion of said water circulating through the closed-loop pipework system;

filtering the diverted water to remove particulate contaminants from the diverted water to produce cleaned water; and

returning the cleaned water into the closed-loop pipework system.

Removing particulate contaminants from the water circulating through the pipework system and returning cleaned water into the pipework system may therefore serve to condition the pipework system by removing contaminants such as corrosion debris, debris which has entered the pipework during installation of the pipework and biological material which is present within the pipework. The method enables a closed-loop pipework system of a heat exchanger to be cleaned without the need to flush large volumes of water through the pipework system and without generating large volumes of effluent which must be disposed of.

The water delivered to the closed-loop pipework system and circulated through the closed-loop pipework system preferably includes conditioned water, which is produced during the further method step of removing further particulate contaminants from the water and killing microorganisms in the water.

Delivering conditioned water into a closed-loop pipework system of a heat exchanger may preventingress of physical and microbiological contaminants into the pipework system. The particulate contaminants removed include one or more of corrosion debris, debris which has entered the pipework during installation of the pipework and biological material.

The step of producing conditioned water preferably further includes removing biological material from the water following killing microorganisms in the water. In an embodiment, biological material is removed by passing the water through a microbiological filter and then a microbiological membrane barrier. Removing microorganisms which have been killed by the disinfection apparatus and biological material present within the water received from the first water inlet before the water is delivered into the pipework system may minimize microbiological fouling and microbiological induced corrosion within a closed-loop heat exchanger pipework system.

Preferably, each of the steps of removing particulate contaminants and further particulate contaminants includes filtering the water.

In an embodiment, the closed-loop pipework system has a volumetric capacity and said proportion of the water circulating through the closed-loop pipework system is diverted at a rate of a volume of water substantially equivalent to said volumetric capacity in a period of substantially one hour. Diverting the water from the closed-loop pipework system for processing by the pipework conditioning apparatus may enable physical removal of microbiological contaminants, installation debris and abrasion debris from within the closed-loop pipework system.

The method may further include de-aerating the removed water. Removing air from the water circulating through the pipework system may reduce the growth of microorganisms in the water and may reduce the introduction of particulate contaminants and biological material into the water due to impact of air bubbles with internal surfaces of the pipework system.

Preferably, the method further includes delivering a dose of at least one of an anti-corrosion chemical composition, a water conditioning chemical composition and an anti-microbial chemical composition into at least one of the conditioned water and the cleaned water prior to the said water being delivered into the closed-loop pipework system. Delivering an anti-corrosion chemical composition into the water may reduce the amount of corrosion which occurs on the internal surfaces of the pipework system, thus reducing the amount of corrosion debris which may build up in the water circulating through the pipework system. Delivering a water conditioning chemical composition into the water may inhibit the formation of scale on the internal surfaces of the pipework system, thus reducing the amount of scale debris which may build up in the water circulating through the pipework system. Delivering an anti-microbial chemical composition into the water may inhibit the growth of biological material within the pipework system, thus reducing the amount of biological material which may build up in the water circulating through the pipework system. The amount of anti-microbial chemical composition required to inhibit growth of biological material may be reduced as a result of the water conditioning apparatus having killed microorganisms in the water.

In an embodiment, the heat exchanger further includes a secondary pipework system, and the method further includes:

diverting water from the closed-loop pipework system into the secondary pipework system;

flushing the diverted water through the secondary pipework system;

removing further particulate contaminants from the water that has been flushed through the secondary pipework system to produce cleaned water; and

returning the cleaned water into the closed-loop pipework system.

The method enables separate cleaning of a secondary pipework system which is isolated from the closed-loop pipework system during cleaning of the closed-loop pipework system.

In an embodiment, the method includes flushing the water through the secondary pipework system into a water tank prior to removing particulate contaminants from the water. Water may therefore be flushed through the secondary pipework system into the tank at a higher rate than the flow capacity of the third filtration apparatus or a time when it is not possible to return cleaned water into the closed-loop pipework system, with the water then having particulate contaminants removed at a lower rate or at a later time.

The heat exchanger may include an air-conditioning system.

Embodiments of the invention will now be described in detail, by way of example only, with reference to the accompanying drawings.

### BRIEF DESCRIPTION OF THE DRAWINGS

FIG. 1 is a schematic representation of closed-loop heat exchanger pipework cleaning apparatus according to a first embodiment of the present application.

FIG. 2 is a schematic representation of closed-loop heat exchanger pipework cleaning apparatus according to a second embodiment of the present application;

FIG. 3 is a schematic representation of closed-loop heat exchanger pipework cleaning apparatus according to a third embodiment of the present application;

FIG. 4 is a schematic representation of closed-loop heat exchanger pipework cleaning apparatus according to a fourth embodiment of the present application;

FIG. 5 is a schematic representation of water conditioning apparatus which may be used in the closed-loop heat exchanger pipework cleaning apparatus of FIG. 4;

FIG. 6 is a schematic representation of pipework conditioning apparatus which may be used in the closed-loop heat exchanger pipework cleaning apparatus of FIG. 4;

FIG. 7 is a schematic representation of closed-loop heat exchanger pipework cleaning apparatus according to a fifth embodiment of the present application;

FIG. 8 is a schematic representation of back-flushing apparatus which may be used in the closed-loop heat exchanger pipework cleaning apparatus of FIG. 7;

FIG. 9 is a schematic representation of closed-loop heat exchanger pipework cleaning apparatus according to a sixth embodiment of the present application;

FIG. 10 is a schematic representation of back-flushing apparatus which may be used in the closed-loop heat exchanger pipework cleaning apparatus of FIG. 9;

FIG. 11 is a schematic representation of a closed-loop heat exchanger according to a seventh embodiment of the present application;

FIG. 12 shows steps of a method of cleaning a closed-loop heat exchanger pipework system, according to an eighth embodiment of the present application; and,

FIG. 13 shows steps of a method of cleaning a closed-loop heat exchanger pipework system, according to a ninth embodiment of the present application.

### DETAILED DESCRIPTION OF THE PREFERRED EMBODIMENTS

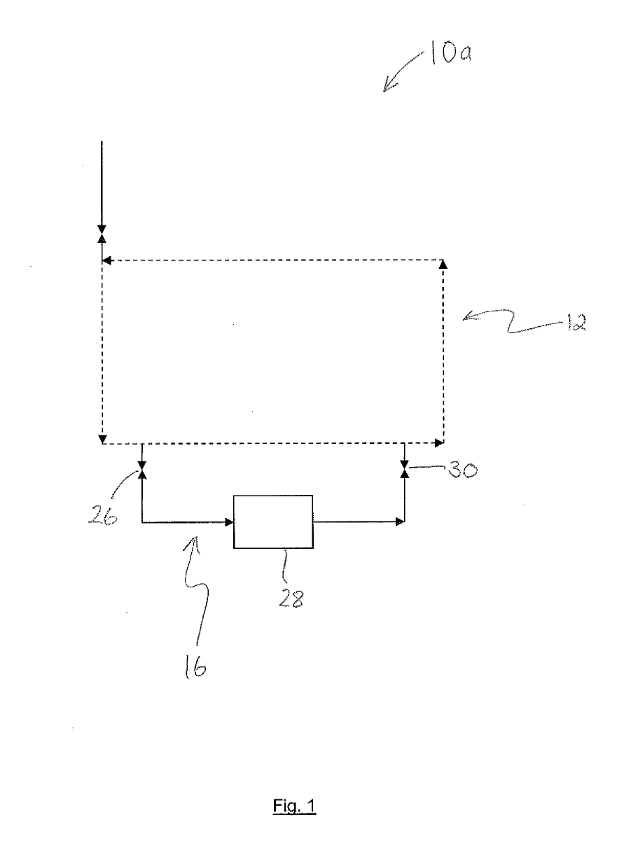

Referring to FIG. 1, a first embodiment of the present application provides a closed-loop heat exchanger pipework cleaning apparatus 10a according to first embodiment of the present application. FIG. 1 also shows, in dashed lines, a schematic representation of a closed-loop heat exchanger pipework system 12 with which the apparatus 10a of the present application may be used. The closed-loop heat exchanger pipework system 12 shown in FIG. 1 does not form part of this embodiment and is merely shown for illustrative purposes.

The closed-loop heat exchanger pipework cleaning apparatus 10a includes pipework conditioning apparatus 16, which includes a first water inlet 26, first filtration apparatus 28 and a first water outlet 30. The first water inlet 26 is adapted to divert water from the closed-loop pipework system 12 into the pipe conditioning apparatus 16. The first filtration apparatus 28 is adapted to remove particulate contaminants from the water diverted from the closed-loop pipework system 12 to produce cleaned water. The first water outlet 30 is adapted to deliver the cleaned water into the closed-loop pipework system 12.

In use, the water in the pipework system 12 is caused to circulate through the system and while the water is circulating a proportion of the water is diverted into the pipework conditioning apparatus 16. The diverted water passes through the first filtration apparatus 28 to form cleaned water, which is then returned into the closed-loop pipework system 12. Over a period of time, the pipework conditioning apparatus 16 will process a substantial part of the water circulating through the closed-loop pipework system 12, thereby removing further particulate contaminants from the circulating water. In this way, the pipework system 12 may be conditioned without the need to flush water through the pipework system 12 to drain.

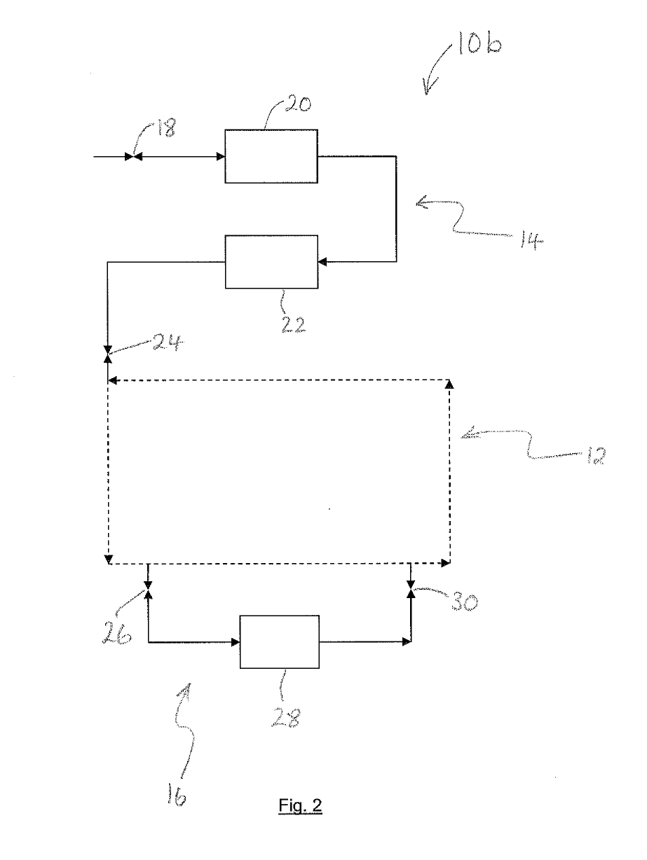

Referring to FIG. 2 of the drawings, there is illustrated a closed-loop heat exchanger pipework cleaning apparatus 10b according to a second embodiment of the present application. The apparatus 10b of this embodiment is substantially the same as the apparatus 10a of the first embodiment, with the following modifications. The same reference numbers are retained for corresponding features. FIG. 2 similarly includes a closed-loop pipework system 12 for illustrative purposes only.

In this example, the closed-loop heat exchanger pipework cleaning apparatus 10b further includes water conditioning apparatus 14. The water conditioning apparatus 14 is adapted to receive water and to remove further particulate contaminates from the water and to kill microorganisms in the water, to produce conditioned water. The water conditioning apparatus 14 is further adapted to deliver the conditioned water into the closed-loop pipework system 12 until the closed-loop pipework system 12 is substantially full of water.

The water conditioning apparatus 14 includes a second water inlet 18, second filtration apparatus 20 and disinfection apparatus 22. The water inlet 18 is adapted to receive the water, which may be raw water, for example rain water or river water, or may be treated water received from a mains water supply. The second filtration apparatus 20 is adapted to remove further particulate contaminants from the water received through the water inlet 18. The disinfection apparatus 22 is adapted to kill microorganisms in the water. The disinfection apparatus 22 is shown in FIG. 2 in flow series after the second filtration apparatus 20, but it will be appreciated that the order of the second filtration apparatus 20 and the disinfection apparatus 22 may be reversed.

The water conditioning apparatus 14 further includes a second water outlet 24 adapted to deliver the conditioned water into the closed-loop pipework system 12.

In use, water is received through the second water inlet 18 and enters the water conditioning apparatus 14. The water is conditioned by the second filtration apparatus 20 removing particulate contaminants and the disinfection apparatus 22 killing micro-organisms in the water. The conditioned water is delivered into the closed-loop pipework system 12, until it is filled. The water in the pipework system 12 is then caused to circulate through the system and while the water is circulating a proportion of the water is diverted into the pipework conditioning apparatus 16 via the first water inlet 26, for cleaning as described in relation to the first embodiment.

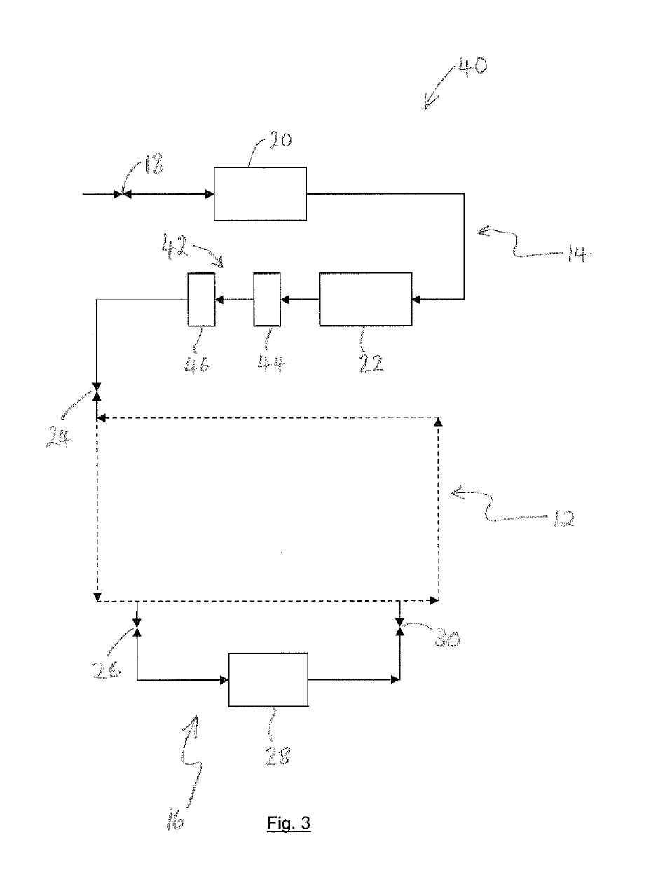

FIG. 3 shows a closed-loop heat exchanger pipework cleaning apparatus 40 according to a third embodiment of the present application. The apparatus 40 of this embodiment is substantially the same as the apparatus 10b of the second embodiment, with the following modifications. The same reference numbers are retained for corresponding features. FIG. 3 similarly includes a closed-loop pipework system 12 for illustrative purposes only.

In this example, the disinfection apparatus 22 includes an ultraviolet (UV) light based water disinfection apparatus. The construction and operation of such devices will be well known to the person skilled in the art and so will not be described in detail here. The second filtration apparatus 20 includes a plurality of spun cotton and resin filters arranged to filter out particles having a size of greater than 1-25 μm.

In this embodiment, the water conditioning apparatus 14 further includes biological filtration apparatus 42 adapted to receive the water from the disinfection apparatus 22 and to remove biological material from the water. In this example, the biological filtration apparatus 42 includes a microbiological filter 44 and a microbiological membrane barrier 46 arranged together in series.

The biological filtration apparatus 42 enables biological material to be removed from the water, including microorganisms which have been killed by the disinfection apparatus 22.

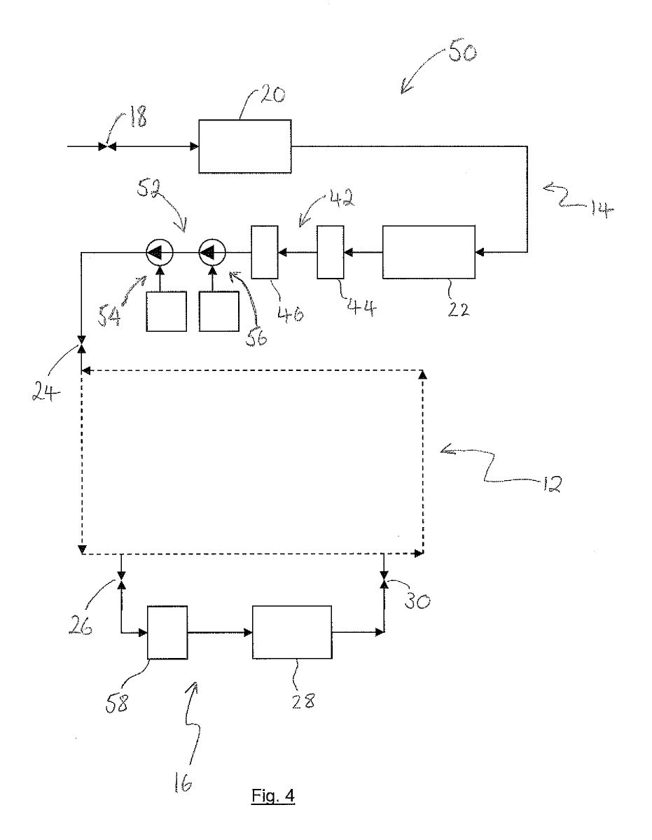

A fourth embodiment of the present application provides closed-loop heat exchanger pipework cleaning apparatus 50, as shown in FIG. 4. The apparatus 50 of this embodiment is substantially the same as the apparatus 40 of FIG. 3, with the following modifications. The same reference numbers are retained for corresponding features. A closed-loop pipework system 12 is again included for illustrative purposes only.

In this embodiment, the water conditioning apparatus 14 further includes conditioning chemical delivery apparatus 52. The conditioning chemical delivery apparatus 52 is adapted to deliver a dose of at least one of an anti-corrosion chemical composition, a water conditioning chemical composition and an anti-microbial chemical composition into the conditioned water, following the microbiological membrane barrier 46. In this example, two chemical composition dosing units 54, 56 are provided which deliver doses of an anti-corrosion chemical composition and water conditioning chemical composition mixture and an anti-microbial chemical composition respectively.

It will be appreciated that the conditioning chemical delivery apparatus 52 may alternatively be provided within the pipework conditioning apparatus 16, and that conditioning chemical delivery apparatus 52 may be provided within both the water conditioning apparatus 14 and pipework conditioning apparatus 16.

In this example, the pipework conditioning apparatus 16 further includes a de-aerator 58 which is arranged to receive the water diverted from the closed-loop pipework system 12 and to remove air from the water before it is processed by the first filtration apparatus 28.

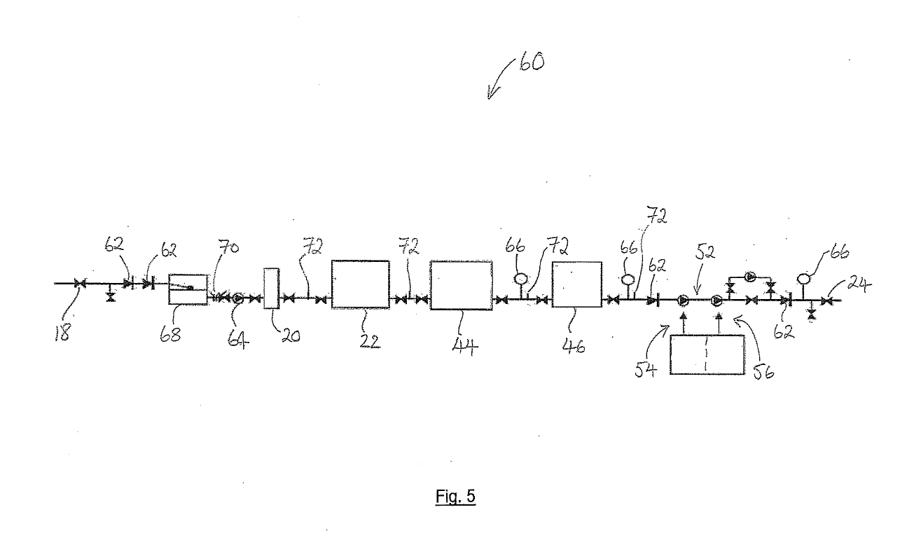

FIG. 5 shows water conditioning apparatus 60 which may be used in the closed-loop heat exchanger pipework cleaning apparatus 50 of FIG. 4. The same reference numbers are used for corresponding features.

The water conditioning apparatus 60 further includes a number of non-return valves 62 and pumps 64 in order to control the flow of the diverted water through the water conditioning apparatus 60. A vacuum break tank 68 and flow measuring device 70 are also provided to control the flow of the diverted water through the water conditioning apparatus 60. A number of pressure gauges 66 are provided to monitor the pressure of the water flow.

The water conditioning apparatus 60 further includes a number of testing points 72 at which samples of the water flowing through the water conditioning apparatus may be diverted for measurement of microorganism levels. The level of microbiological activity within a sample may be measured using an adenosine triphosphate (ATP) device. This is a commercially available measuring system and its construction and operation will be well known to the person skilled in the art, and so it is not described in detail here.

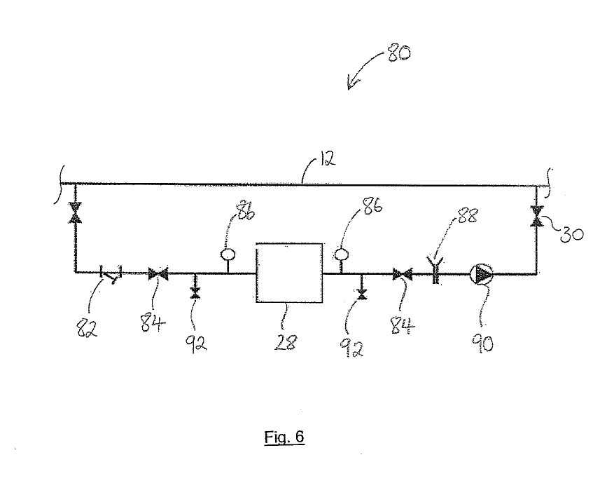

FIG. 6 shows pipework conditioning apparatus 80 which may be used in the closed-loop heat exchanger pipework cleaning apparatus 50 of FIG. 4. The same reference numbers are retained for corresponding features. The location of the closed-loop pipework system 12 is shown for illustrative purposes only.

In this example, the pipework conditioning apparatus 80 additionally includes a strainer 82, two non-return valves 84, a pressure gauge 86 on either side of the second filtration apparatus 28, a flow meter 88 and a pump 90. Two test points 92 are also provided at which the level of conditioning chemicals and/or microbiological levels in the water flowing through the pipework conditioning apparatus may be measured, allowing further doses of conditioning chemical compounds to be introduced into said water in response.

The pressure gauges 86 enable the flow rate across the first filtration apparatus 28 to be determined, allowing an operator to determine whether one or more filters within the filtration apparatus 28 require to be replaced, a reduction in flow rate through the filtration apparatus 28 indicating that the filters are becoming clogged with particulate contaminants.

Closed-loop heat exchanger pipework cleaning apparatus 100 according to a fifth embodiment of the present application is shown in FIG. 7. The apparatus 100 is substantially the same as the apparatus 10b of FIG. 2, with the following modifications. The same reference numbers are retained for corresponding features.

The closed-loop heat exchanger pipework cleaning apparatus 100 of this embodiment is for use in cleaning a heat exchanger which includes a closed-loop pipework system 12 and a secondary pipework system 102. The secondary pipework system 102 is isolated from the closed-loop pipework system 12 during cleaning of the closed-loop pipework system 12. Both the closed-loop pipework system 12 and the secondary pipework system 102 are shown for illustrative purposes only and do not form part of this embodiment.

In this embodiment, the closed-loop heat exchanger pipework cleaning apparatus 100 further includes back-flushing apparatus 104. The back-flushing apparatus 104 includes third filtration apparatus 106 and a third water outlet 108. The third filtration apparatus 106 is adapted to receive water from the secondary pipework system 102 and to remove further particulate contaminants to produce further cleaned water. The third water outlet is adapted to return the resulting cleaned water into the closed-loop pipework system 12.

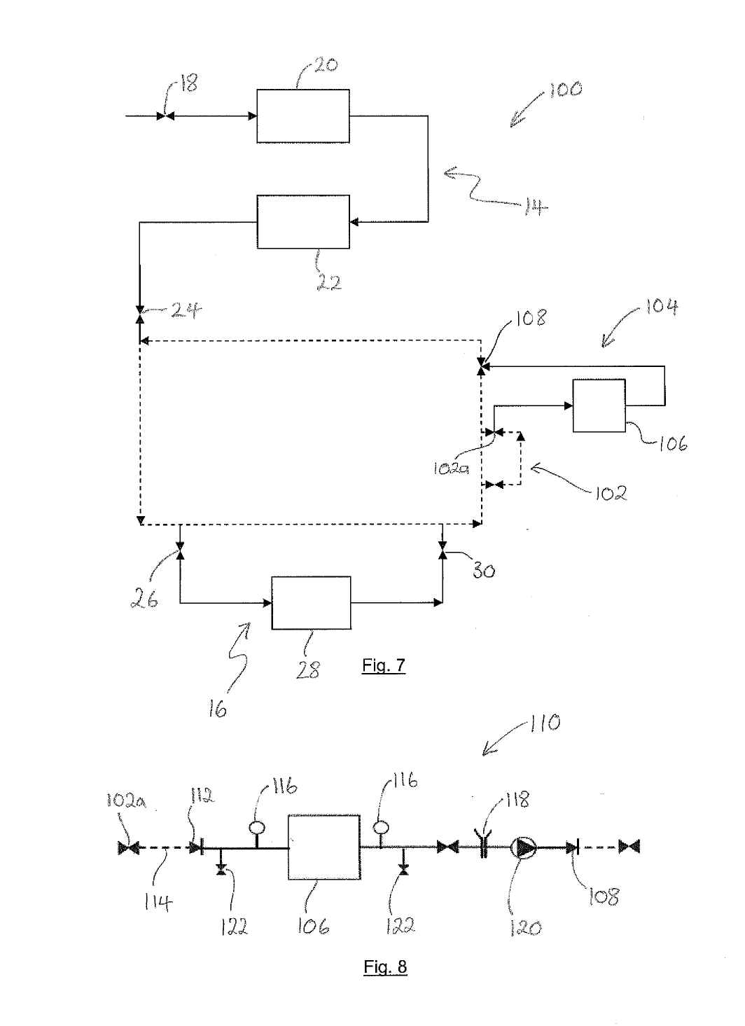

FIG. 8 shows back-flushing apparatus 110 which may be used in the closed-loop heat exchanger pipework cleaning apparatus 100 of FIG. 7. The back-flushing appearance 110 is substantially the same as the apparatus 104 of FIG. 7. The same reference numbers are retained for corresponding features.

The back-flushing apparatus 110 further includes an inlet valve 112 which is coupled to an outlet valve 102a of the secondary pipework system 102 by means of a flexible hose 114. First and second pressure gauges 116 are provided on either side of the third filtration apparatus 106, by which the flow rate through the filtration apparatus 106 may be determined. A flow meter 118 is provided which is adapted to measure the amount of water which has flowed through the back-flushing apparatus 110. A booster pump 120 is provided to pump the cleaned water to the water outlet 108, for return into the closed-loop-pipework system 12. Two test points 122 are also provided at which the water flowing through the back-flushing apparatus 110 may be sampled for testing, as described above.

In use, following the cleaning of the closed-loop pipework system 12, water is diverted from the closed-loop pipework system 12 into the secondary pipework system 102 and is flushed through the secondary pipework system 102 into the back-flushing apparatus 110. The secondary pipework apparatus 102 is thereby cleaned by the water flowing through it dislodging any further particulate contaminants. The water present in the secondary pipework apparatus 102 prior to cleaning is flushed out of the secondary pipework apparatus. The water flushed through the secondary pipework apparatus 102 is received into the back-flushing apparatus 104 where it is cleaned by the third filtration apparatus 106. The resulting cleaned water is then returned into the closed-loop pipework system 12.

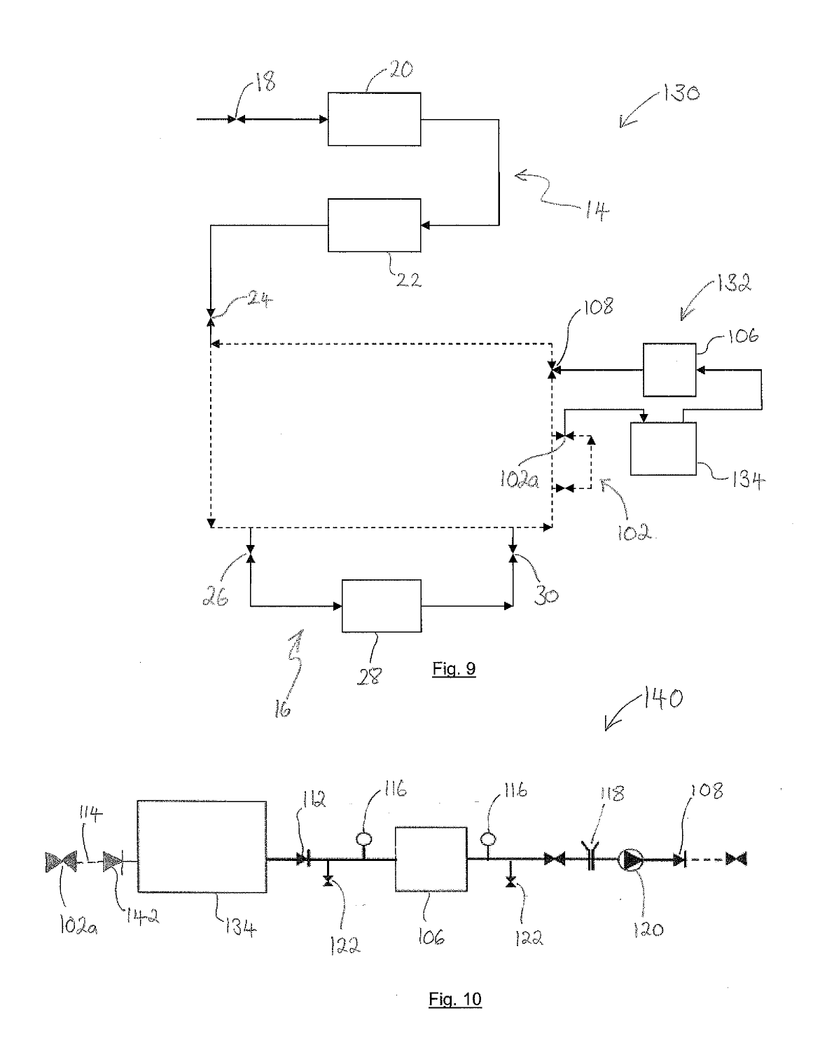

FIG. 9 shows a closed-loop heat exchanger pipework cleaning apparatus 130 according to a sixth embodiment of the present application. The apparatus 130 is substantially the same as the apparatus 100 of FIG. 7, with the following modifications. The same reference numbers are retained for corresponding features. The closed-loop pipework system 12 and the secondary system 102 are again shown for illustration purposes only.

In this embodiment, the back-flushing apparatus 132 further includes a water tank 134, provided between the secondary pipework system 102 and the third filtration apparatus 106. The water tank 134 is adapted to receive the water from the secondary pipework system, and the third filtration apparatus is arranged to receive the water from the water tank 134.

In use, the water diverted from the closed-loop pipework system 12 is flushed through the secondary pipework system 102 into the water tank 134. The water is then delivered from the water tank to the third filtration apparatus 106, where it is cleaned, and the resulting cleaned water is returned into the closed-loop pipework system.

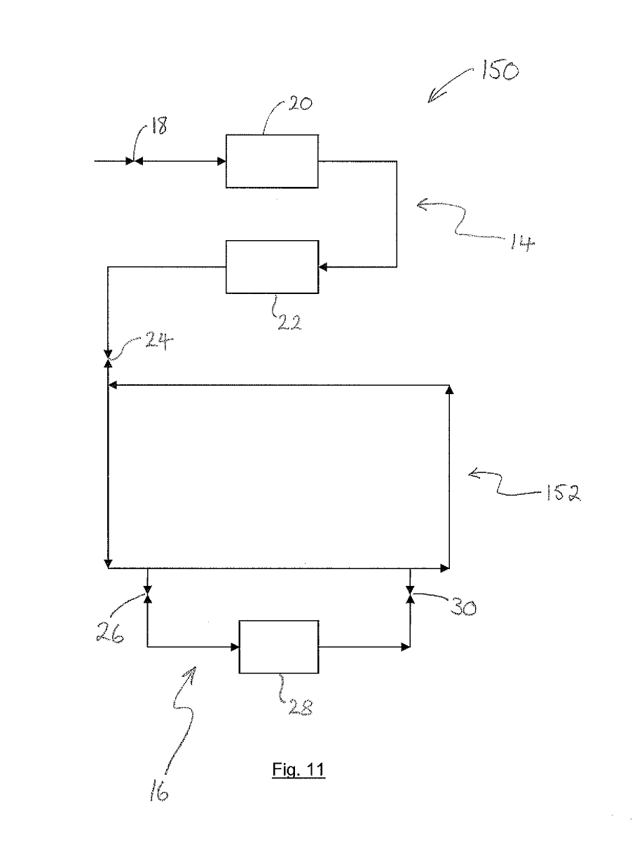

FIG. 10 shows a back-flushing apparatus 140 which may be used with the closed-loop heat exchanger pipework cleaning apparatus 130 of FIG. 9. The apparatus 140 is substantially the same as the back-flushing apparatus 110 of FIG. 8, with the following modifications. The same reference numbers are retained for corresponding features.

In this embodiment, the back-flushing apparatus 140 further includes a water tank 134 and a further inlet valve 142, adapted to control the flow of water from the secondary pipework system 102 into the water tank 134.

A closed-loop heat exchanger 150 according to a seventh embodiment of the present application is shown in FIG. 11.

The closed-loop heat exchanger 150 includes a closed-loop heat exchanger pipework system 152 and closed-loop heat exchanger pipework cleaning apparatus 10b, as shown in FIG. 2.

It will be appreciated that any of the closed-loop heat exchanger pipework cleaning apparatus described above may be used in the heat exchanger 150. It will also be appreciated that the heat exchanger 150 may further include a secondary pipework system, of the type indicated as 102 in FIGS. 7 to 10. Where the heat exchanger 150 further includes secondary pipework apparatus 102 it will be appreciated that the closed-loop heat exchanger pipework cleaning apparatus may be as shown in any of FIGS. 7 to 10.

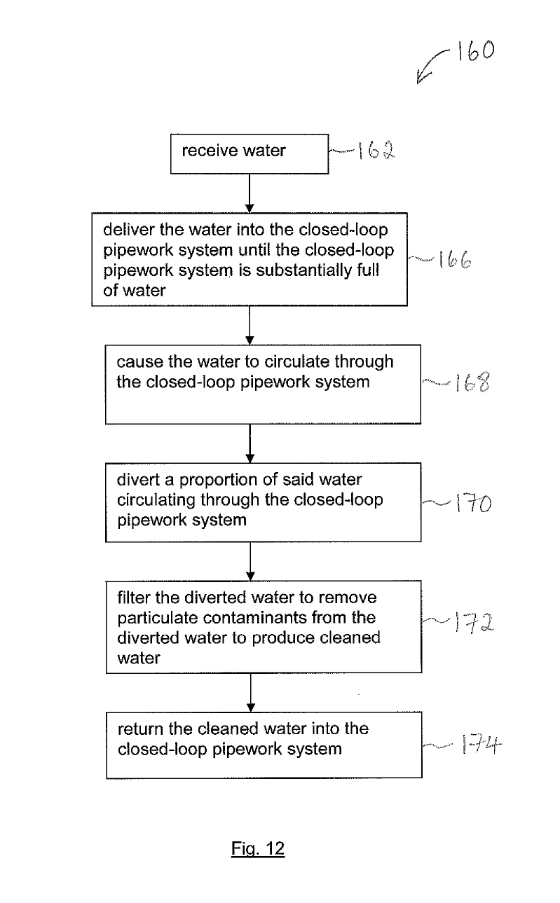

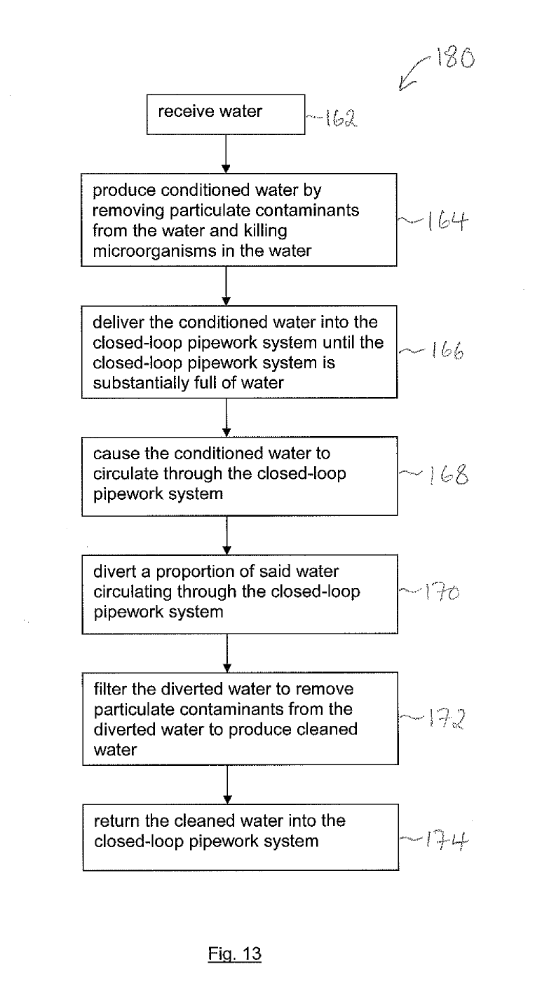

An eighth embodiment of the present application provides a method 160 of cleaning a closed-loop heat exchanger pipework system, as shown in FIG. 12.

The method 160 includes receiving water 162 and then delivering the water into the closed-loop pipework system until the closed-loop pipework system is substantially full of water 166. The closed-loop pipework system may therefore be empty prior to receiving the water or may already have a volume of water in it. The method further includes causing the water to circulate through the closed-loop pipework system 168. It will be noted that where the pipework system contained a volume of water prior to delivery of the water that the existing water will also be caused to circulate through the system. The water may be circulated by operating one or more pumps in the pipework system.

The method 160 further includes diverting a proportion of the water circulating through the closed-loop pipework system 170 and filtering the diverted water to remove particulate contaminants from the diverted water to produce cleaned water 172. The cleaned water is then returned into the closed-loop pipework system 174.

Referring to FIG. 13 of the drawings, there is illustrated a ninth embodiment of the present application, which provides a further method 180 of cleaning a closed-loop heat exchanger pipework system, as shown in FIG. 12. The method includes the steps associated with the method 160 of the eight embodiment and as such, like steps have been referenced using the same numerals.

The method 180 of the ninth embodiment however, includes receiving water 162, from a raw water supply, such as rain water or river water, or from a mains water supply. The method 160 further includes producing conditioned water by removing particulate contaminants from the water and killing microorganisms in the water 164. The conditioned water is then delivered into the closed-loop pipework system until the closed-loop pipework system is substantially full of water 166. The closed-loop pipework system may therefore be empty prior to receiving the conditioned water or may already have a volume of water in it. The method further includes causing the conditioned water to circulate through the closed-loop pipework system 168. It will be noted that where the pipework system contained a volume of water prior to delivery of the conditioned water that the existing water will also be caused to circulate through the system. The water may be circulated by operating one or more pumps in the pipework system.

The method 160 further includes diverting a proportion of the water circulating through the closed-loop pipework system 170 and filtering the diverted water to remove particulate contaminants from the diverted water to produce cleaned water 172. The cleaned water is then returned into the closed-loop pipework system 174.

There have been described and illustrated herein several embodiments of an apparatus and a method of cleaning heat exchanger pipework. While particular embodiments of the invention have been described, it is not intended that the invention be limited thereto, as it is intended that the invention be as broad in scope as the art will allow and that the specification be read likewise. It will therefore be appreciated by those skilled in the art that yet other modifications could be made to the provided invention without deviating from its spirit and scope as claimed.

What is claimed is:

1. An apparatus for use in conjunction with a heat exchanger that includes a closed-loop pipework system for circulating water there through, the apparatus comprising:
a pipework conditioning apparatus adapted to receive a proportion of the water circulating through the closed-loop pipework system of the heat exchanger and to remove particulate contaminants from the received water to produce cleaned water, and to return the cleaned water into the closed-loop pipework system.

2. An apparatus as claimed in claim 1, further comprising:
a first water inlet adapted to divert said proportion of the water into the pipework conditioning apparatus from the closed-loop pipework system;
a first filtration apparatus adapted to remove said particulate contaminants from the water diverted from the closed-loop pipework system to produce the cleaned water; and
a first water outlet adapted to deliver the cleaned water into the closed-loop pipework system.

3. An apparatus as claimed in claim 1, further comprising:
a water conditioning apparatus adapted to receive water and to remove further particulate contaminants from the water and to kill microorganisms in the water, to produce conditioned water, and to deliver the conditioned water into the closed-loop pipework system of the heat exchanger until the closed-loop pipework system is substantially full of water.

4. An apparatus as claimed in claim 3, wherein the water conditioning apparatus comprises:
a second water inlet adapted to receive the water;
a second filtration apparatus adapted to remove said further particulate contaminants from the water;
a disinfection apparatus adapted to kill said microorganisms in the water; and
a second water outlet adapted to deliver the conditioned water into the closed-loop pipework system.

5. An apparatus as claimed in claim 2, wherein:
the closed-loop pipework system has a volumetric capacity and the first water inlet comprises a valve arrangement adapted to divert a volume of the water circulating through the closed-loop pipework system substantially equivalent to said volumetric capacity into the pipework conditioning apparatus in a period of substantially one hour.

6. An apparatus as claimed in claim 1, wherein:
the pipework conditioning apparatus further comprises a de-aerator.

7. An apparatus as claimed in claim 4, wherein:
the water conditioning apparatus further comprises biological filtration apparatus adapted to receive the conditioned water from the disinfection apparatus and to remove biological material from the conditioned water.

8. An apparatus as claimed in claim 7, wherein:
the biological filtration apparatus comprises a microbiological filter and a microbiological membrane barrier arranged in series.

9. An apparatus as claimed in claim 1, further comprising:
a conditioning chemical delivery apparatus adapted to deliver a dose of at least one of an anti-corrosion chemical composition, a water conditioning chemical composition and an anti-microbial chemical composition into the water prior to the said water being delivered into the closed-loop pipework system.

10. An apparatus as claimed in claim 1, wherein:
the heat exchanger further comprises a secondary pipework system, and the apparatus further comprises back-flushing apparatus that includes a third filtration apparatus and a third water outlet, the third filtration apparatus adapted to receive water from the secondary pipework system and to remove further particulate contaminants to produce further cleaned water, and the third water outlet adapted to return the further cleaned water into the closed-loop pipework system.

11. An apparatus as claimed in claim 10, wherein:
the back-flushing apparatus further comprises a water tank, provided between the secondary pipework system and the third filtration apparatus and adapted to receive the water from the secondary pipework system, the third filtration apparatus being arranged to receive the water from the water tank.

12. A heat exchanger comprising:
a closed-loop pipework system for circulating water therethrough;
a pipework cleaning apparatus adapted to receive a proportion of the water circulating through the closed-loop pipework system and to remove particulate contaminants from the received water to produce cleaned water, and to return the cleaned water into the closed-loop pipework system.

13. A heat exchanger as claimed in claim 12, further comprising:
a secondary pipework system;
wherein the heat exchanger pipework cleaning apparatus further comprises a back-flushing apparatus including a third water inlet, a third filtration apparatus, and a third water outlet, the third water inlet adapted to divert water from the closed-loop pipework system into the secondary pipework system, the third filtration apparatus adapted to receive water from the secondary pipework system and to remove further particulate contaminants to produce further cleaned water, and the third water outlet adapted to return the cleaned water into the closed-loop pipework system.

14. A heat exchanger as claimed in claim 13, wherein:
the back-flushing apparatus further comprises a water tank, provided between the secondary pipework system and the third filtration apparatus and adapted to receive the water from the secondary pipework system, the third filtration apparatus being arranged to receive the water from the water tank.

15. A method of cleaning a closed-loop heat exchanger pipework system, the method comprising:
receiving water;
delivering the water into a closed-loop pipework system of a heat exchanger until the closed-loop pipework system is substantially full of water;
causing the water to circulate through the closed-loop pipework system;
diverting a proportion of said water circulating through the closed-loop pipework system;
filtering the diverted water to remove particulate contaminants from the removed water to produce cleaned water; and
returning the cleaned water into the closed-loop pipework system.

16. A method as claimed in claim 15, wherein:
the water delivered to the closed-loop pipework system and circulated around the pipework system comprises conditioned water, which is produced during the further method step of removing further particulate contaminants from the water and killing microorganisms in the water.

17. A method as claimed in claim 16, wherein:
the producing of conditioned water further includes removing biological material from the water following killing microorganisms in the water.

18. A method as claimed in claim 17, wherein:
the biological material is removed by passing the water through a microbiological filter and then a microbiological membrane barrier.

19. A method as claimed in claim 15, wherein:
the removing of particulate contaminants involves filtering the water.

20. A method as claimed in claim 15, wherein:
the closed-loop pipework system has a volumetric capacity and said proportion of the water circulating through the closed-loop pipework system is diverted at a rate of a volume of water substantially equivalent to said volumetric capacity in a period of substantially one hour.

21. A method as claimed in claim 15, further comprising:
de-aerating the removed water.

22. A method as claimed in claim 15, further comprising:
delivering a dose of at least one of an anti-corrosion chemical composition, a water conditioning chemical composition and an anti-microbial chemical composition into at least one of the conditioned water and the cleaned water prior to the said water being delivered into the closed-loop pipework system.

23. A method as claimed in claim 15, wherein the heat exchanger further comprises a secondary pipework system, and the method further comprises:
diverting water from the closed-loop pipework system into the secondary pipework system;
flushing the diverted water through the secondary pipework system;
removing further particulate contaminants from the water that has been flushed through the secondary pipework system to produce cleaned water; and
returning the cleaned water into the closed-loop pipework system.
